(19) United States
(12) Patent Application Publication
(10) Pub. No.: US 2015/0039425 A1
(43) Pub. Date: Feb. 5, 2015

(54) NOTIFICATION SYSTEM

(71) Applicant: International Business Machines Corporation, Armonk, NY (US)

(72) Inventors: Lazarek Jagoda, Lodz (PL); Zohar Feldman, Haifa (IL)

(73) Assignee: International Business Machines Corporation, Armonk, NY (US)

(21) Appl. No.: 13/958,642

(22) Filed: Aug. 5, 2013

(51) Int. Cl. G06Q 30/02

(52) U.S. Cl. CPC G06Q 30/0255
USPC 705/14.53

(57) ABSTRACT

A method comprising using at least one hardware processor for: receiving historical responsiveness data of an offeree; computing predicted responsiveness of the offeree to one or more present offers, wherein said computing is based on the historical responsiveness data and is performed regardless of a content of the one or more present offers.

### BACKGROUND

The invention relates to the field of notification systems, such as those used for marketing offers, assignments sent to field agents, etc.

Direct marketing approaches are constantly evolving and becoming more complex. In addition to traditional methods of making an offer through direct mail or telemarketing, channels such as email or online offers through a website have increased the number of campaigns that the marketer may consider.

Furthermore, advances in analytical software in recent years have provided marketers with better predictive models of their customer behavior, and these models often have a very high degree of sophistication. For example, it is not uncommon to have separate models of response probability for an offer, such as a credit card offer, through the call center, direct mail, and email. The marketer would like to use this information to determine the best course of action when deciding which customers should receive each offer through each channel. An objective is to maximize or minimize some quantitative measure of the offers that are made, such as maximizing the expected response probability or the expected profit, or minimizing total cost. As a further complication to the problem, marketing actions are limited by business constraints that are to be satisfied.

The foregoing examples of the related art and limitations related therewith are intended to be illustrative and not exclusive. Other limitations of the related art will become apparent to those of skill in the art upon a reading of the specification and a study of the figures.

### SUMMARY

The following embodiments and aspects thereof are described and illustrated in conjunction with systems, tools and methods which are meant to be exemplary and illustrative, not limiting in scope.

There is provided, in accordance with an embodiment, a method comprising using at least one hardware processor for: receiving historical responsiveness data of an offeree; computing predicted responsiveness of the offeree to one or more present offers, wherein said computing is based on the historical responsiveness data and is performed regardless of a content of the one or more present offers.

There is provided, in accordance with an embodiment, a computer program product for computing predicted responsiveness of an offeree to one or more present offers, the computer program product comprising a non-transitory computer-readable storage medium having program code embodied therewith, the program code executable by at least one hardware processor to: receive historical responsiveness data of an offeree; and compute predicted responsiveness of the offeree to one or more present offers, wherein said compute is based on the historical responsiveness data and is performed regardless of a content of the one or more present offers.

In some embodiments, said computing is based on the Markov Decision Process.

In some embodiments, the Markov Decision Process is formulated as (S, A, R, Tr), where: S is a set of values from the historical responsiveness data of the offeree; A is the one or more present offers; R is a computed value of the one or more present offers to an offeror; and Tr is a stochastic transition computed based on S and A.

In some embodiments, the method further comprises using said at least one hardware processor for computing an effect of transmitting the one or more present offers on future responsiveness of the offeree.

In some embodiments, the historical responsiveness data comprises feedback provided by the offeree as to a historical offer.

In some embodiments, the historical responsiveness data comprises ignoring a historical offer by the offeree.

In some embodiments, the method further comprises using said at least one hardware processor for transmitting the one or more present offers to the offeree.

In some embodiments, said transmitting comprises transmitting a push notification to a portable computing device of the offeree.

In some embodiments, said transmitting comprises transmitting an electronic message to the offeree.

In some embodiments, said transmitting comprises initiating a telephone call to the offeree.

In some embodiments, said transmitting comprises automatically producing a paper mail item addressed to the offeree.

In some embodiments, said program code is further executable by said at least one hardware processor to compute an effect of transmitting the one or more present offers on future responsiveness of the offeree.

In some embodiments, said program code is further executable by said at least one hardware processor to transmit the one or more present offers to the offeree.

In addition to the exemplary aspects and embodiments described above, further aspects and embodiments will become apparent by reference to the figures and by study of the following detailed description.

### BRIEF DESCRIPTION OF THE FIGURES

Exemplary embodiments are illustrated in referenced figures. Dimensions of components and features shown in the figures are generally chosen for convenience and clarity of presentation and are not necessarily shown to scale. The figures are listed below.

FIG. 1 shows a flowchart of a method for computing predicted responsiveness of an offeree to an offer; and

FIG. 2 shows a network diagram of a computing device which transmits an offer to an offeree.

### DETAILED DESCRIPTION

Disclosed herein is a method for computing predicted responsiveness of an offeree to an offer made by an offeror. The method may have, for example, an offline mode and an online mode. The offline mode may serve to compute a general policy of making offers by the offeror. The online mode, on the other hand, may be used in an ad-hoc fashion, to decide whether to make an offer or skip it in a particular point in time.

The term “offer”, as referred to herein, relates to any notification which may be sent from a sender (the “offeror”) to a recipient (the “offeree”), where the recipient can act upon the notification in one or more ways. This acting upon the notification is hereinafter referred to as “responding” to the notification, even though it does not necessarily include a response sent back from the recipient to the sender. The notification may include various types of content. Examples include marketing offers, assignments sent to field agents, etc.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a hardware processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

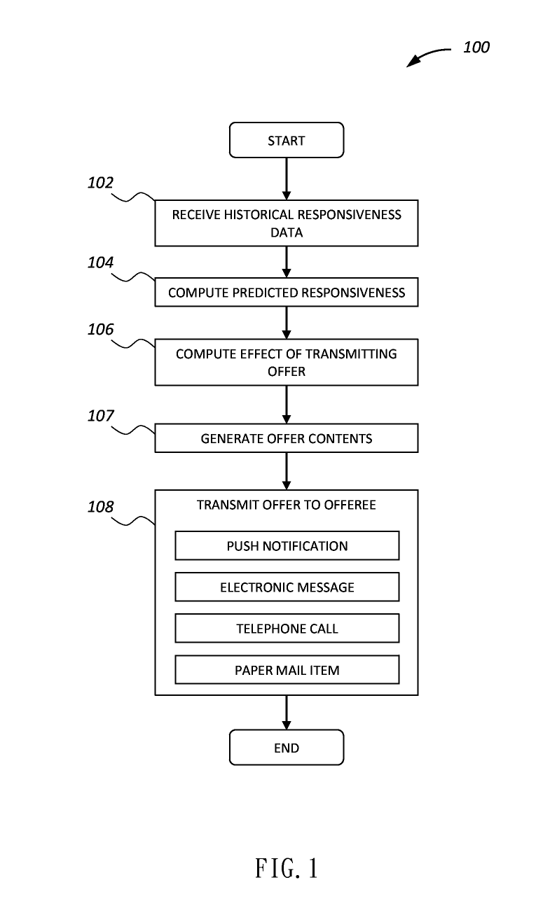

Reference is now made to FIG. 1, which shows a flowchart of a method 100 for computing predicted responsiveness of an offeree to an offer made by an offeror, in accordance with an embodiment.

In a step 102, method 100 may include receiving historical responsiveness data of an offeree. The historical responsiveness data may include, for example, prior responses of the offeree to offers made by the same or a different offeror. The term “responses” may refer to the offeree actively reviewing a prior offer, expressing acceptance of the prior offer, carrying out an action prescribed by the prior offer, sending a response to the offeror, and/or the like.

Optionally, the historical responsiveness data is a vector of values, wherein each value may be binary (for example, a positive or a negative response to an offer) or be on a scale of more than two options. For example, a binary historical responsiveness vector {positive, positive, negative} is indicative of two prior positive responses to offers, followed by a single negative response. An example of a scaled historical responsiveness vector may be {90%, 10%, 55%}, indicative of different levels or responsiveness of the offeree to three different prior offers. Optionally, the historical responsiveness vector may include a time stamp for one or more of the values, this time stamp being indicative of when each response occurred.

In a step 104, predicted responsiveness of the offeree to the offer is computed, based on the historical responsiveness data of that offeree. Advantageously, the computation of the predicted responsiveness may yield a responsiveness score, which is indicative of the probability that the act of providing the offer will have a positive result. The term “positive result”, to list a few examples, may refer to the offeree actively reviewing the offer, expressing acceptance of the offer, carrying out an action prescribed by the offer, sending a response to the offeror, and/or the like.

The responsiveness score may be either binary or on a scale of more than two levels. For example, a binary score may simply indicate whether a positive result is anticipated or not. A scale having more levels, on the other hand, may be more finely indicative of the probability of yielding a positive result.

In some embodiments, the computation of the predicted responsiveness of the offeree to the one or more present offers may be based on the Markov Decision Process (MDP). As known in the art, MDPs provide a mathematical framework for modeling decision making in situations where outcomes are partly random and partly under the control of a decision maker—in this case the offeree.

The MDP, in accordance with some embodiments, may be formulated as (S, A, R, Tr), where:

S (for State) is a set of values from the historical responsiveness data of the offeree, namely—the historical responsiveness vector, which is indicative of the offeree's present state. Optionally, the historical responsiveness vector also includes a timestamp for some or all of its values.

A (for Actions) is the one or more present offers;

R (for Reward) is a computed value of the one or more present offers to an offeror; and

Tr (for Transition) is a stochastic transition function, computed based on S and A. Tr determines a probability to transition from a particular state to another state when applying a certain action. For example, if a state is represented by the last two responses of the user, then the probability to transfer from state {Accepted, Rejected} to state {Rejected, Accepted} by applying an action of recommending a content with match probability 0.9 is the probability that the recommended content was considered and accepted by the user. This can be calculated as the probability that the offeree would consider some content given his current state {Accepted, Rejected} multiplied by the probability that the new content matches his interest (0.9)

In some embodiments, the computation of the predicted responsiveness of the offeree to the one or more present offers may be based on the contents of the one or more present offers. For example, the computation may take into account the fit of a certain offer to a certain offeree. Optionally, the effect on timing on the predicted responsiveness may also be part of the computation.

Optionally, in a step 106, an effect of transmitting the one or more present offers on future responsiveness of the offeree is computed. Namely, in addition to the computing of the responsiveness score, which is indicative of the probability that the act of providing the offer will have an immediate positive result, the method may also compute the effect of transmitting the offer on the offeree's responsiveness to future offers. This may enable the offeree to set up a long-term policy of making offers. By way of example, even if the method initially determines that sending the offer is anticipated to yield immediate positive results, the computation of the effect on future offers may indicate that the future results outweigh the immediate ones. In other words, in the long run, it may be better not to transmit an offer to a certain offeree, so as not to harm the chances of this offeree being responsive to future offers. With reference to the MDP discussed above, a solution to the MDP is a policy and/or a decision that maximizes a desired objective such as the expected overall rewards.

Optionally, in a step 107, following the computation of the predicted responsiveness and based on the responsiveness score, contents of the offer may be generated and/or received from a user or from a different system.

Optionally, in a step 108, following the generation or the receipt of the offer's contents, the offer may be transmitted to the offeree. This transmission may take place, for example, if the responsiveness score is above a certain threshold, or if the binary responsiveness score indicates that a positive result is indeed anticipated. The transmission may be carried out, by way of example, as a push notification sent over a network, such as the Internet, to a portable computing device (e.g. a smart phone) of the offeree. Further examples include transmitting an electronic message, such as an email or an SMS (short message service) message, to the offeree; transmitting an electronic message to appear in a software application installed on a portable computing device of the offeree; initiating a marketing-oriented telephone call—whether automatically or semi-automatically—to the offeree; and producing a paper mail item addressed to the offeree, such as by automatically printing the name and address of the offeree on the paper mail item.

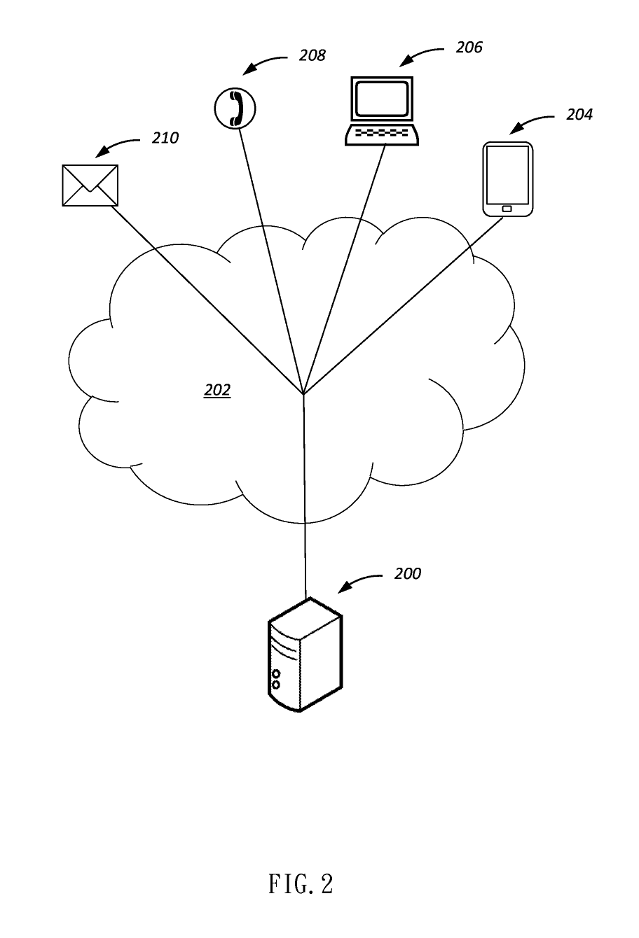

Reference is now made to FIG. 2, which shows a network diagram of a computing device 200 configured to execute at least some of the steps of method 100 of FIG. 1. The computing device may be further configured to transmit one or more offers, over a network 202, to one or more offerees. As discussed, the transmission may be, for example, to a computing device such as a smart phone 204 and/or a desktop/portable computer 206 of the offeree, over a network 202 such as the Internet. As another example, the transmission may include the automatic printing of a paper mail item 210 addressed to the offeree, such as in the course of a direct marketing campaign where the postal service serves as the network 202. As a further example, The transmission may include initiating a telephone call 208 to the offeree, either fully automatically or semi-automatically. In a fully-automatic mode, a pre-recorded marketing call may be made to the offeree. In a semi-automatic mode, the call me be initiated automatically but be carried out by a human telemarketer.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising using at least one hardware processor for:
receiving historical responsiveness data of an offeree; and
computing predicted responsiveness of the offeree to one or more present offers, wherein said computing is based on the historical responsiveness data and is performed regardless of a content of the one or more present offers.

2. The method according to claim 1, wherein said computing is based on the Markov Decision Process.

3. The method according to claim 2, wherein the Markov Decision Process is formulated as (S, A, R, Tr), where:
S is a set of values from the historical responsiveness data of the offeree;
A is the one or more present offers;
R is a computed value of the one or more present offers to an offeror; and
Tr is a stochastic transition computed based on S and A.

4. The method according to claim 1, further comprising using said at least one hardware processor for computing an effect of transmitting the one or more present offers on future responsiveness of the offeree.

5. The method according to claim 1, wherein the historical responsiveness data comprises feedback provided by the offeree as to a historical offer.

6. The method according to claim 1, wherein the historical responsiveness data comprises ignoring a historical offer by the offeree.

7. The method according to claim 1, further comprising using said at least one hardware processor for transmitting the one or more present offers to the offeree.

8. The method according to claim 7, wherein said transmitting comprises transmitting a push notification to a portable computing device of the offeree.

9. The method according to claim 7, wherein said transmitting comprises transmitting an electronic message to the offeree.

10. The method according to claim 7, wherein said transmitting comprises initiating a telephone call to the offeree.

11. The method according to claim 7, wherein said transmitting comprises automatically producing a paper mail item addressed to the offeree.

12. A computer program product for computing predicted responsiveness of an offeree to one or more present offers, the computer program product comprising a non-transitory computer-readable storage medium having program code embodied therewith, the program code executable by at least one hardware processor to:
receive historical responsiveness data of an offeree; and
compute predicted responsiveness of the offeree to one or more present offers, wherein said compute is based on the historical responsiveness data and is performed regardless of a content of the one or more present offers.

13. The computer program product according to claim 12, wherein said computing is based on the Markov Decision Process.

14. The computer program product according to claim 13, wherein the Markov Decision Process is formulated as (S, A, R, Tr), where:
S is a set of values from the historical responsiveness data of the offeree;
A is the one or more present offers;
R is a computed value of the one or more present offers to an offeror; and
Tr is a stochastic transition computed based on S and A.

15. The computer program product according to claim 12, wherein said program code is further executable by said at least one hardware processor to compute an effect of transmitting the one or more present offers on future responsiveness of the offeree.

16. The computer program product according to claim 12, wherein the historical responsiveness data comprises feedback provided by the offeree as to a historical offer.

17. The method according to claim 1, wherein the historical responsiveness data comprises ignoring a historical offer by the offeree.

18. The computer program product according to claim 12, wherein said program code is further executable by said at least one hardware processor to transmit the one or more present offers to the offeree.

19. The computer program product according to claim 18, wherein said transmit comprises transmitting a push notification to a portable computing device of the offeree.

20. The computer program product according to claim 18, wherein said transmit comprises transmitting an electronic message to the offeree.
